(19) United States
(12) Patent Application Publication
(10) Pub. No.: US 2026/0085707 A1
(43) Pub. Date: Mar. 26, 2026

(54) Compliant Stud Retainer

(71) Applicant: Illinois Tool Works Inc., Glenview, IL (US)

(72) Inventors: Thomas A. Benoit, New Bourbonnais, IL (US); Paul D. Barkauski, New Lenox, IL (US)

(21) Appl. No.: 19/335,622

(22) Filed: Sep. 22, 2025

Related U.S. Application Data
(60) Provisional application No. 63/699,230, filed on Sep. 26, 2024.

(51) Int. Cl. F16B 2/20; F16B 7/04

(52) U.S. Cl. CPC F16B 2/20; F16B 7/04

(57) ABSTRACT

A stud-retention assembly for securing a fastener to a stud includes a hinged ring clip and a retainer insert. The retainer insert attaches to the stud and is captured within the hinged ring clip, which allows the insert to move slightly both rotationally and linearly. This design provides compliance to accommodate misaligned studs, permits interchangeable retainer inserts for different stud sizes, and enables easy servicing or replacement without removing the clip.

### RELATED APPLICATION

The present application claims priority to United States Provisional Patent Application No. 63/699,230, filed September 26, 2024, and entitled “Compliant Stud Retainer,” which is hereby incorporated by reference in its entirety.

### BACKGROUND

Vehicular (e.g., automotive) components often require attachment and fastening methods that are simple to manufacture and assemble. In many cases, objects must be secured to the vehicle to prevent movement or shifting during operation, which could otherwise result in damage, kinking, or rattling of the object. For example, tubes, hoses, wires, and other conduits are commonly secured to vehicle structures using tube fasteners.

Fastening techniques for attaching tube fasteners must be both reliable and efficient. In some examples, a tube fastener can be secured to the vehicle via a stud. However, alignment can present challenges. Original Equipment Manufacturers (OEMs) increasingly request features that allow for greater build variation while still enabling operators to make easy adjustments. Conventional stud retainer designs typically permit only limited build variation, and usually in a single direction.

Accordingly, despite existing advancements, there remains a need for a fastener that provides a greater range of build variation while ensuring components remain in the correct position. Such additional compliance can help reduce assembly issues and mitigate no-build scenarios caused by poor build tolerances.

### SUMMARY

The present disclosure relates generally to a fastening system to form a connection between two components, such as vehicular components and tubes (or other objects), using a compliant fastener assembly that can couple with a stud, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a fastening system configured to secure one or more second components relative to a first component having a stud thereon via a compliant fastener assembly in accordance with an aspect of this disclosure.

FIG. 2a illustrates a topside isometric view of the compliant fastener assembly of FIG. 1 with its hinged ring clip in a closed, loaded position.

FIG. 2b illustrates a topside isometric view of the compliant fastener assembly of FIG. 1 with its hinged ring clip in an open, loaded position.

FIGS. 2c and 2d illustrate topside isometric views of the compliant fastener assembly in, respectively, a first offset position and a second offset position.

FIG. 2e illustrates a topside isometric detailed view of the compliant fastener assembly of FIG. 1 with its hinged ring clip in an open, unloaded position.

FIG. 3 illustrates a topside isometric view of the compliant fastener assembly in a closed, loaded position with a retainer insert in accordance with another aspect.

FIG. 4 illustrates a topside isometric view of the compliant fastener assembly in an open, loaded position with a retainer insert in accordance with yet another aspect.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A compliant fastener assembly may be utilized to couple a second component to a first component that includes a stud. The compliant fastener assembly comprises a retainer insert configured to deflect or translate to accommodate build variation, while still permitting operators to perform adjustments and ensuring that the coupled components are maintained in the desired position.

In one example, a stud-retention assembly for securing a fastener to a stud of a component comprises: a hinged ring clip defining a pocket with an annular slot; and a retainer insert configured to be movably retained within the pocket of the hinged ring clip, the retainer insert comprising one or more stud-engagement features configured to fixedly couple the retainer insert to the stud, wherein the hinged ring clip comprises a first portion joined to a second portion via a hinge, the first and second portions pivotable between an open position and a closed position configured to capture the retainer insert within the pocket.

In some examples, the annular slot is configured to permit linear and rotational movement of the retainer insert within the pocket.

In some examples, the retainer insert is circular.

In some examples, the hinge is a living hinge.

In some examples, the compliant fastener assembly further comprises a catch on the first portion configured to engage a snap on the second portion to secure the hinged ring clip in the closed position.

In some examples, the retainer insert comprises a pair of spaced-apart disks joined by a hollow cylinder.

In some examples, the stud-engagement features comprise one or more cantilevered tangs.

In some examples, the stud-engagement features comprise one or more inwardly biased arms or snap-in fingers.

In some examples, the stud-engagement features comprise one or more barbs or serrations.

In another example, a compliant fastener assembly for securing one or more components to a first component having a stud comprises: a carrier portion configured to receive one or more second components; and a fastener portion coupled to the carrier portion via a spacer portion, the fastener portion comprising a stud-retention assembly having a hinged ring clip defining a pocket with an annular slot; and a retainer insert configured to be movably retained within the pocket of the hinged ring clip, the retainer insert comprising one or more stud-engagement features configured to fixedly couple the retainer insert to the stud, wherein the hinged ring clip comprises a first portion joined to a second portion via a hinge, the first and second portions pivotable between an open position and a closed position configured to capture the retainer insert within the pocket, and wherein the spacer portion is configured to accommodate a length of the stud extending beyond the retainer insert.

In some examples, the pocket and movable retainer insert are configured to absorb misalignment of the stud without imparting strain to the second components.

In some examples, the compliant fastener assembly further comprises a lid pivotally coupled to the carrier portion via a hinge, the lid movable between an open position to insert second components and a closed position to retain the second components.

In some examples, the fastener assembly is formed via injection molding or additive manufacturing.

In yet another example, a stud-retention assembly for securing a fastener to a stud of a component comprises: a hinged ring clip comprising a first portion and a second portion joined via a hinge, the first and second portions pivotable between an open position and a closed position; and a retainer insert movably retained within a pocket defined by the hinged ring clip, the retainer insert comprising one or more stud-engagement features configured to fixedly couple the retainer insert to the stud, wherein, in the closed position of the hinged ring clip, the retainer insert is captured within the pocket but permitted to move rotationally and linearly within the pocket.

In some examples, the hinge is a living hinge.

In some examples, the pocket comprises annular slot configured to permit movement of the retainer insert.

In some examples, the retainer insert comprises a pair of spaced-apart disks joined by a hollow cylinder.

In some examples, the retainer insert comprises a pair of spaced-apart disks joined by a hollow cylinder, and wherein the pocket comprises annular slot configured to receive at least a portion of the pair of spaced-apart disks.

In some examples, the stud-engagement features comprise one or more cantilevered tangs, inwardly biased arms, or snap-in fingers.

In some examples, the hinged ring clip is fabricated as a unitary structure.

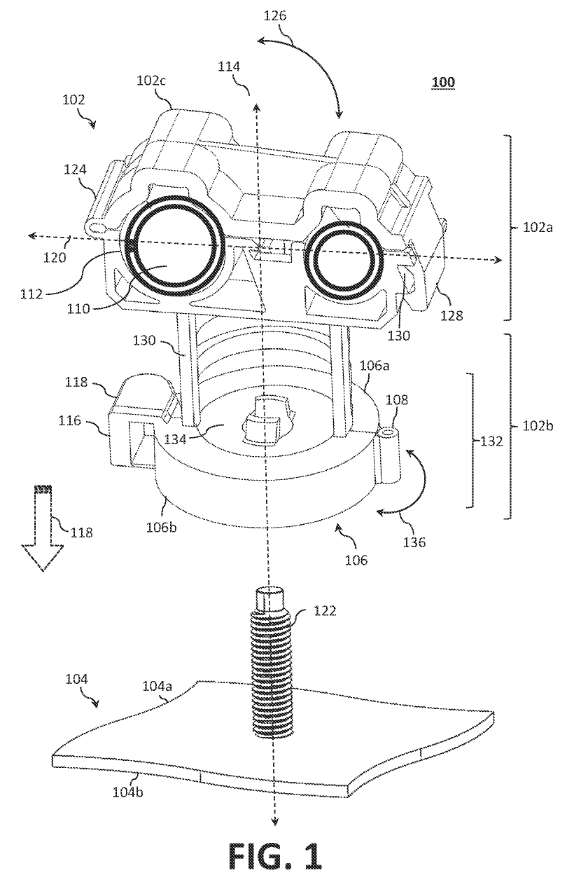

FIG. 1 illustrates a fastening system 100 configured to secure one or more second components 110 relative to a first component 104 having a stud 122, via a compliant fastener assembly 102, in accordance with aspects of the present disclosure.

In the illustrated example, the first component 104 defines an A-side surface 104a (e.g., an exterior surface) from which the stud 122 extends, and a B-side surface 104b (e.g., an interior surface). In some examples, the stud 122 may be threaded (as illustrated) or otherwise textured to increase friction between the stud 122 and the compliant fastener assembly 102 (i.e., the retainer insert 134). The stud 122 can be, for example, an M6 fastener. In other examples, the stud 122 may be substantially smooth or featureless, in which case the compliant fastener assembly 102 may be configured to gouge, bite, or otherwise locally deform into the stud 122 material to enhance retention.

The one or more second components 110 are shown as being secured to the A-side surface 104a, though in other examples the second components 110 may be secured at other positions relative to the first component 104. The first component 104 may be, for example, an automotive panel or structural element, such as a door, an A-pillar, B-pillar, or C-pillar, dashboard cross member, seat frame, center console, fender, or other metal framework. The first component 104 may be fabricated from metals or metal alloys, synthetic or semi-synthetic polymers (e.g., ABS, PVC, or other plastics), fiber composites, or combinations thereof. The second components 110 may include brake lines, fuel lines, electrical cables or harnesses, conduits, fluid pipes, or other elongated members that require secure routing.

The compliant fastener assembly 102 includes a carrier portion 102a and a fastener portion 102b. In the illustrated example, the fastener portion 102b is oriented generally perpendicular to the carrier portion 102a such that a central axis 114 extends through the fastener portion 102b and is orthogonal to a lateral axis 120 extending along the carrier portion 102a. The fastener portion 102b may be formed integrally with the carrier portion 102a (e.g., via injection molding, additive manufacturing, etc.) or may be separately fabricated and mechanically, adhesively, or otherwise coupled thereto. In some examples, the compliant fastener assembly 102, other than the retainer insert 134, is fabricated as a unitary structure.

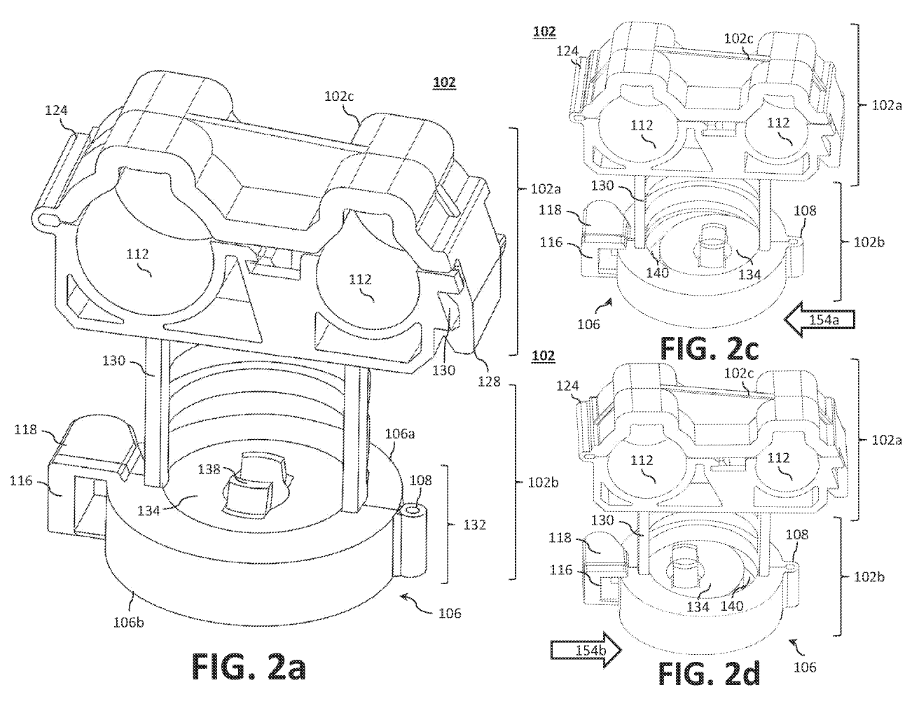

FIGS. 2a–2e illustrate various views of the compliant fastener assembly 102 of FIG. 1. FIG. 2a illustrates a topside isometric view of the compliant fastener assembly 102 of FIG. 1 with its hinged ring clip 106 in a closed, loaded position, while FIG. 2b illustrates a topside isometric view of the compliant fastener assembly 102 of FIG. 1 with its hinged ring clip 106 in an open, loaded position. FIGS. 2c and 2d illustrate topside isometric views of the compliant fastener assembly 102 in, respectively, a first offset position and a second offset position. Finally, FIG. 2e illustrates a topside isometric detailed view of the compliant fastener assembly 102 of FIG. 1 with its hinged ring clip 106 in an open, unloaded position.

In the illustrated example, the fastener portion 102b comprises a stud-retention assembly 132 coupled to the carrier portion 102a via a spacer portion 130. The stud-retention assembly 132 includes the hinged ring clip 106 and a retainer insert 134, where the hinged ring clip 106 receives and movably secures the retainer insert 134 within an annular pocket 140. The retainer insert 134 is configured to fixedly couple to the stud 122. The spacer portion 130 is positioned between the stud-retention assembly 132 and the carrier portion 102a. The spacer portion 130is configured to accommodate the length of the stud 122 that extends beyond the retainer insert 134. The dimensions of the spacer portion 130 may be selected based on the anticipated stud lengths. In some examples, an opening may be formed through the carrier portion 102a along the central axis 114 such that the stud 122 extends into or passes through the carrier portion 102a.

The illustrated carrier portion 102a is configured to secure one or more second components 110 relative to the first component 104. In the illustrated example, the carrier portion 102a defines a plurality of pockets 112, each configured to receive a respective second component 110. Each pocket 112 may be generally cylindrical and sized such that its inner diameter corresponds to the outer diameter of the retained component 110. Different pockets 112 may be dimensioned to receive second components 110 of differing diameters.

To secure the second components 110, the carrier portion 102a may further include a lid 102c pivotally coupled to the body of the carrier portion 102a via a hinge 124. The hinge 124 may be, for example, a living hinge, which is a thin flexible section of the same material allowing repeated bending; a molded pin or barrel hinge, where one part rotates around an integral pin; a snap-fit hinge, using a flexible arm that clicks into a slot; or a flexure/compliant hinge, designed with thin strips or specialized geometry for precise motion.

The lid 102c pivots between an open position and a closed position, as indicated by arrow 126. In the open position, a second component 110 may be urged into its respective pocket 112. In the closed position, the lid 102c covers the pocket openings to retain the components 110 in place. A snap feature 128 formed at the free end of the lid 102c engages a corresponding ledge or protrusion on the carrier portion 102a to lock the lid 102c in the closed position. In other examples, the lid 102c may be omitted and the second components 110 may instead be secured by interference or detent features formed at the pocket entrances.

Although primarily described herein with reference to retaining tubular second components 110, the compliant fastener assembly 102 may also be used to attach, secure, or otherwise position wires, cables, conduits, hoses, or other elongated components relative to the first component 104. In other words, the stud-retention assembly 132 can be used with other forms of fastener and should not be limited to a routing clip.

While the carrier portion 102a retains the second components 110, the fastener portion 102b attaches the fastener assembly 102 to the first component 104. Unlike conventional designs, which are rigid and typically tolerate dimensional variation only along a single axis, the disclosed stud-retention assembly 132 incorporates a compliant retainer insert 134 captured within the hinged ring clip 106. This configuration provides additional degrees of freedom for positional adjustment while still ensuring secure fastening to the stud 122 of the first component 104.

The stud-retention assembly 132 comprises a retainer insert 134 and the hinged ring clip 106. The hinged ring clip 106 defines a pocket 140 with one or more annular 142 that movably retain the retainer insert 134. The generally circular shape of the retainer insert 134 and the hinged ring clip 106 allows for rotational movement about the central axis 114, while the oversized geometry permits the retainer insert 134 to shift linearly (e.g., side-to-side, front-to-back. etc.) within the plane of the pocket 140. This compliance allows the fastener assembly 102 to absorb build variation or misalignment of the stud 122 without imparting strain to the second components 110.

The hinged ring clip 106 includes a first portion 106a joined to a second portion 106b via a hinge 108. The hinge 108 may be, for example, a living hinge, which is a thin flexible section of the same material allowing repeated bending; a molded pin or barrel hinge, where one part rotates around an integral pin; a snap-fit hinge, using a flexible arm that clicks into a slot; or a flexure/compliant hinge, designed with thin strips or specialized geometry for precise motion.

The two portions pivot about the hinge 108 between an open position and a closed position, as indicated by arrow 136. In the open position, the retainer insert 134 may be inserted, removed, or replaced. In the closed position, the retainer insert 134 is captured within the pocket 140 but permitted to float within its oversized dimensions via annular 142 defined by annular ridges 146. To secure the hinged ring clip 106 in the closed position, a catch 118 formed on the first portion 106a engages a snap 116 formed on the second portion 106b.

The retainer insert 134 serves as the primary attachment interface between the stud 122 and the remainder of the fastener assembly 102. The retainer insert 134 may include one or more stud-engagement features 138 and a pair of spaced-apart disks 148 (e.g., circular disks) joined by a hollow cylinder 152 (e.g., a tube) with an opening 150 therethrough. The stud-engagement features 138 fixedly couple the retainer insert 134 to the stud 122, thereby anchoring the fastener assembly 102 to the first component 104. The stud-engagement features 138 comprise, for example, one or more of barbs, serrations, grooves, inwardly biased arms, snap-in fingers, cantilevered tangs, circlips, E-clips, or C-clips, which can engage with a circumferential groove formed on the stud 122.

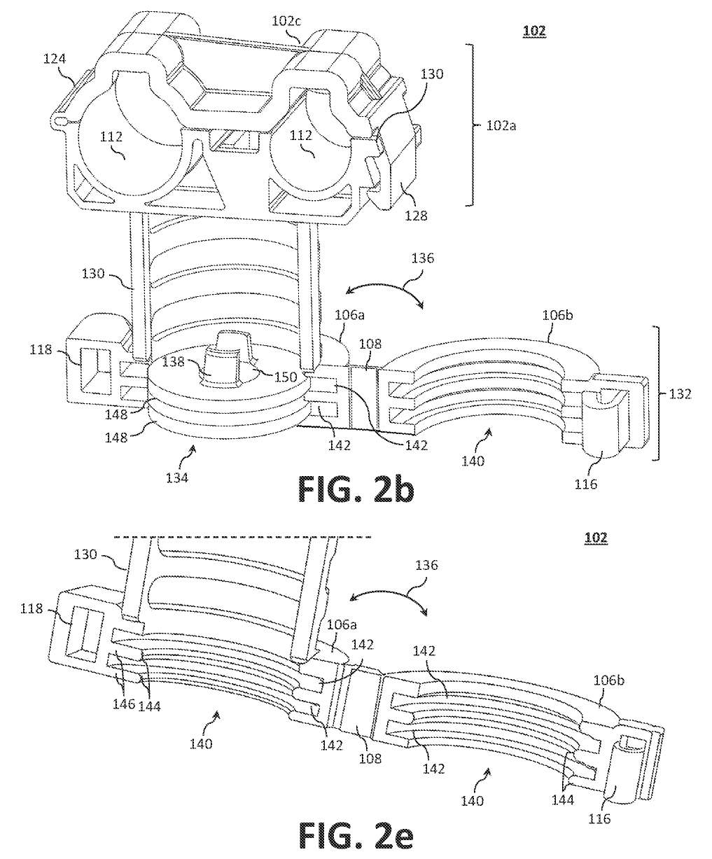

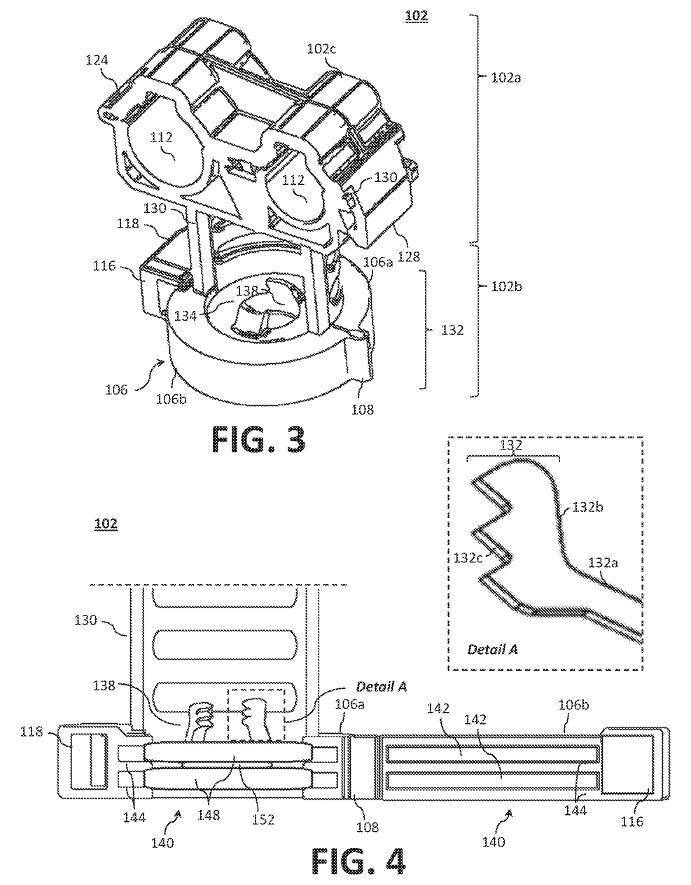

The retainer insert 134 is interchangeable. Different inserts 134 may be installed within the same hinged ring clip 106 to accommodate studs of different sizes, such as M6, M8 (e.g., FIG. 3) or other diameters or configuration (e.g., FIG. 4), without requiring unique tooling. This interchangeability reduces production complexity, facilitates customization, and allows servicing by replacing only the retainer insert 134 while reusing the hinged ring clip 106 (and remainder of the compliant fastener assembly 102).

The inner surface of the pocket 140 can define annular 142 configured to capture edge portions of the retainer insert 134. The annular 142 and annular ridges 146 may include rounded or chamfered edges 144 to reduce binding during movement of the retainer insert 134 within the pocket 140. In operation, the retainer insert 134 is slidably retained between the spaced-apart disks 148 and the corresponding annular 142 defined between the annular ridges 146. As illustrated in FIGS. 2c and 2d, while the retainer insert 134 remains fixed relative to the stud 122, the compliant fastener assembly 102 may rotate about the central axis 114 and shift relative to the retainer insert 134 (and thus relative to the first component 104), as indicated by example arrows 154a and 154b.

The compliant fastener assembly 102, including the carrier portion 102a, the fastener portion 102b, and the hinged ring clip 106, may be manufactured via injection molding. In alternative examples, the fastener assembly 102 may be fabricated using additive manufacturing techniques such as fused deposition modeling, stereolithography, or selective laser sintering. Additive manufacturing may permit different portions of the fastener assembly 102 to be printed at different resolutions—for example, the carrier portion 102a at a lower resolution to reduce build time, and the fastener portion 102b at a higher resolution for greater dimensional precision. Layer thicknesses may range from approximately 100 µm down to 16 µm.

The stud-retention assembly 132, incorporating the retainer insert 134 and the hinged ring clip 106, provides multiple advantages. First, the oversized pocket 140 enables compliance and absorption of build variation, ensuring that the second components 110 remain correctly routed even if the stud 122 is misaligned. Second, the interchangeability of inserts 134 allows a single clip design to support multiple stud sizes, reducing the need for specialized tooling and unique part numbers. Third, the hinged ring clip 106 permits servicing and replacement of inserts 134 without damaging the clip, thereby extending component life. Finally, by isolating the compliant retainer insert 134 from the carrier portion 102a, adjustments to stud engagement do not transfer strain to the routed second components 110.

The one or more stud-engagement features 138 of the retainer insert 134 may be implemented in various forms to suit different fastening applications, including barbs, serrations, grooves, or snap-fit collars.

FIG. 3 illustrates a topside isometric view of the compliant fastener assembly 102 in a closed, loaded position with a retainer insert 134 in accordance with another aspect. In this example, the retainer insert 134 includes one or more stud-engagement features 138 configured to engage an M8 stud.

FIG. 4 illustrates a topside isometric view of the compliant fastener assembly 102 in an open, loaded position with a retainer insert 134 in accordance with yet another aspect. In this example, the retainer insert 134 includes one or more stud-engagement features 138 embodied as inwardly biased arms. In this design, the retainer insert 134 comprises a plurality of resilient arms 132a extending inward toward a central opening. Each arm 132a terminates in a foot 132b configured to engage the stud 122 by interference fit. The foot 132b may further include friction features 132c, such as ridges, teeth, barbs, or roughened surfaces, to increase pull-out resistance. During installation, the arms 132a resiliently deflect outward to receive the stud 122 and then spring back to their biased position, thereby locking the retainer insert 134 to the stud 122.

Other examples of the retainer insert 134 may employ different geometries of stud-engagement features 138. In some examples, the retainer insert 134 may include compliant leaf structures that flex radially to capture the stud 122. In other examples, the retainer insert 134 may include segmented rings or split collars that contract around the stud 122 once installed. In still further examples, snap-in fingers or cantilevered tangs may be used to engage a groove, shoulder, or undercut formed on the stud 122.

The stud-engagement features 138 may also be configured to suit studs of varying surface conditions. For example, for a smooth stud 122, the retainer insert 134 may include sharp serrations or cutting edges to gouge into the stud surface and generate mechanical interlock. For a threaded stud 122, the retainer insert 134 may include complementary thread segments or partial helical ribs to mate with the stud threads. For a grooved stud 122, the retainer insert 134 may include inwardly directed lips or snap beads that seat within the groove to prevent axial displacement.

By providing multiple interchangeable forms of the retainer insert 134, the compliant fastener assembly 102 can be adapted to different stud diameters, surface finishes, and retention requirements without redesigning the hinged ring clip 106. This interchangeability enables a single clip architecture to be deployed across different vehicle platforms and fastening scenarios, thereby reducing part proliferation, simplifying assembly processes, and accommodating a wide range of build variations.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A stud-retention assembly for securing a fastener to a stud of a component, the assembly comprising:
a hinged ring clip defining a pocket with an annular slot; and
a retainer insert configured to be movably retained within the pocket of the hinged ring clip, the retainer insert comprising one or more stud-engagement features configured to fixedly couple the retainer insert to the stud,
wherein the hinged ring clip comprises a first portion joined to a second portion via a hinge, the first and second portions pivotable between an open position and a closed position configured to capture the retainer insert within the pocket.

2. The stud-retention assembly of claim 1, wherein the annular slot is configured to permit linear and rotational movement of the retainer insert within the pocket.

3. The stud-retention assembly of claim 1, wherein the retainer insert is circular.

4. The stud-retention assembly of claim 1, wherein the hinge is a living hinge.

5. The stud-retention assembly of claim 1, further comprising a catch on the first portion configured to engage a snap on the second portion to secure the hinged ring clip in the closed position.

6. The stud-retention assembly of claim 1, wherein the retainer insert comprises a pair of spaced-apart disks joined by a hollow cylinder.

7. The stud-retention assembly of claim 1, wherein the stud-engagement features comprise one or more cantilevered tangs.

8. The stud-retention assembly of claim 1, wherein the stud-engagement features comprise one or more inwardly biased arms or snap-in fingers.

9. The stud-retention assembly of claim 1, wherein the stud-engagement features comprise one or more barbs or serrations.

10. A compliant fastener assembly for securing one or more components to a first component having a stud, the compliant fastener assembly comprising:
a carrier portion configured to receive one or more second components; and
a fastener portion coupled to the carrier portion via a spacer portion, the fastener portion comprising a stud-retention assembly having
a hinged ring clip defining a pocket with an annular slot; and
a retainer insert configured to be movably retained within the pocket of the hinged ring clip, the retainer insert comprising one or more stud-engagement features configured to fixedly couple the retainer insert to the stud,
wherein the hinged ring clip comprises a first portion joined to a second portion via a hinge, the first and second portions pivotable between an open position and a closed position configured to capture the retainer insert within the pocket, and
wherein the spacer portion is configured to accommodate a length of the stud extending beyond the retainer insert.

11. The compliant fastener assembly of claim 10, wherein the pocket and movable retainer insert are configured to absorb misalignment of the stud without imparting strain to the second components.

12. The compliant fastener assembly of claim 10, further comprising a lid pivotally coupled to the carrier portion via a hinge, the lid movable between an open position to insert second components and a closed position to retain the second components.

13. The compliant fastener assembly of claim 10, wherein the fastener assembly is formed via injection molding or additive manufacturing.

14. A stud-retention assembly for securing a fastener to a stud of a component, the assembly comprising:
a hinged ring clip comprising a first portion and a second portion joined via a hinge, the first and second portions pivotable between an open position and a closed position; and
a retainer insert movably retained within a pocket defined by the hinged ring clip, the retainer insert comprising one or more stud-engagement features configured to fixedly couple the retainer insert to the stud,
wherein, in the closed position of the hinged ring clip, the retainer insert is captured within the pocket but permitted to move rotationally and linearly within the pocket.

15. The stud-retention assembly of claim 14, wherein the hinge is a living hinge.

16. The stud-retention assembly of claim 14, wherein the pocket comprises annular slot configured to permit movement of the retainer insert.

17. The stud-retention assembly of claim 14, wherein the retainer insert comprises a pair of spaced-apart disks joined by a hollow cylinder.

18. The stud-retention assembly of claim 14, wherein the retainer insert comprises a pair of spaced-apart disks joined by a hollow cylinder, and wherein the pocket comprises annular slot configured to receive at least a portion of the pair of spaced-apart disks.

19. The stud-retention assembly of claim 14, wherein the stud-engagement features comprise one or more cantilevered tangs, inwardly biased arms, or snap-in fingers.

20. The stud-retention assembly of claim 14, wherein the hinged ring clip is fabricated as a unitary structure.
